(19) United States
(12) Patent Application Publication
(10) Pub. No.: US 2025/0312949 A1
(43) Pub. Date: Oct. 9, 2025

(54) COMPRESSION MOULDING DEVICE AND METHOD

(71) Applicant: SACMI COOPERATIVA MECCANICI IMOLA SOCIETA' COOPERATIVA, IMOLA (IT)

(72) Inventors: FABRIZIO PUCCI, CASTEL GUELFO DI BOLOGNA (IT); FIORENZO PARRINELLO, MEDICINA (IT); DAVIDE ZANOTTI, IMOLA (IT); FRANCESCO PIRAZZOLI, IMOLA (IT); GIOVANNI MAZZOTTI, BOLOGNA (IT); ELEONORA BALDUCCI, MONDOLFO (IT)

(21) Appl. No.: 18/865,010

(22) PCT Filed: May 18, 2023
(86) PCT No.: PCT/IB2023/055109

§ 371 Date: Nov. 12, 2024

(30) Foreign Application Priority Data
May 25, 2022 (IT) 102022000010850

(51) Int. Cl. B29C 43/02; B29C 43/32; B29K 1/00; B29L 31/56

(52) U.S. Cl. CPC B29C 43/021; B29C 43/32; B29C 2043/3205; B29K 2001/00; B29L 2031/565

(57) ABSTRACT

Described is a compression moulding device and method, wherein the device comprises: a female element (2) for housing a dose made of material suitable for compression moulding; a male punch (5) which can be at least partly inserted in the female element (2) to compress said dose and make a relative product; wherein said punch (5) has an outer surface (10) for moulding the dose, and wherein said punch (5) comprises a first portion (6) slidable relative to at least a second portion (7) between a moulding condition wherein the second portion (7) radially compresses the dose against the female element (2) and a collapsed condition wherein the second portion (7) is radially retracted away from the dose.

This invention relates to a device and a method for compression moulding. More specifically, the invention relates to the field of making concave objects by moulding, such as, for example, caps or containers of any type such as glasses or bowls.

In more detail, these concave objects are made of a material which can be subjected to compression moulding, typically polymeric-based material, in particular cellulose.

As is known, the moulding devices for producing objects by compression of a dosed quantity of polymeric-based material have a male element provided with a punch and a female element provided with a cavity.

The dose of material is positioned between the cavity and the punch and is compressed by inserting the punch inside the above-mentioned cavity.

It should be noted that the outer surface of the punch and the inner surface of the cavity determine the shape of the product which must be made.

Products may be made, for example, provided with protrusions such as, for example, threads, in the case of the production of caps, obtained from shaped cavities made on the outer surface of the punch.

At the end of the pressing action the punch and the female element are moved away from each other to allow the extraction of the product obtained in this way.

The extraction is actuated by an annular element which extends around the punch and which pressing axially towards the end of the punch allows the product to be detached from the outer surface of the punch.

In this situation, in the above-mentioned case of products provided with protrusions, such as, for example, the caps with the relative threads, the extraction step comprises a slight deformation of the product designed to release the protrusions from the shaped cavities made on the punch. However, this action results in significant drawbacks due precisely to the mechanical stresses which the product just formed undergoes.

In effect, it should be noted that the deformation action, if actuated with particular force by the annular element, can irreversibly break and deform part of the material just moulded, generally precisely the protrusion (thread in the case of caps).

The above-mentioned drawback is even more significant in the case of moulding certain materials, typically cellulose-based materials.

In effect, in this case, the slight deformation designed to release the threads from the surface of the punch can easily damage the cellulose material which is notoriously more fragile than other polymeric materials.

The aim of the invention is therefore to provide a device and relative moulding method which are free of the above-mentioned drawbacks.

More specifically, a first aim of the invention is that of providing a compression moulding device and a method which are able to maintain the condition of the moulded product during every step of its production, in particular during the steps for extraction from the punch.

Yet more specifically, an aim of the invention is to provide a device and relative moulding method which does not require any deformation, even minimal, of the product just moulded.

A further aim is to provide a device and relative compression moulding method suitable for any shape of the product which must be obtained and applicable with any polymeric material, in particular with cellulose-based material.

According to a first aspect of the invention, there is a compression moulding device, comprising: a female element for housing a dose of material suitable for compression moulding and a male punch which can be at least partly inserted in the female element for compressing said dose and making a relative product. The punch has an outer surface for moulding the dose, and comprises a first portion slidable relative to at least a second portion between a moulding condition wherein the second portion radially compresses the dose against the female element and a collapsed condition wherein the second portion is radially retracted away from the dose.

Preferably, the first portion has a cylindrical shape having a plurality of seats alternated with a plurality of outer surfaces. In this situation, the punch comprises a plurality of second portions each of which housed in a respective seat of the first portion.

Even more preferably, each second portion comprises an outer surface adjacent to and interposed between two outer surfaces of the first portion and has cavities configured to define a thread of the product to be moulded. The outer surfaces of the first and second portions in the moulding condition define the outer moulding surface.

According to a particular aspect of the invention, the seats of the first portion are arranged circumferentially along the cylindrical extension of the first portion and the second portions are movable radially towards/away from the longitudinal axis of extension of the first portion.

Preferably, each seat comprises a contact surface inclined and converging towards an end of the punch close to a bottom wall of the female element. Each second portion also comprises a contact surface inclined and converging towards the end of the punch close to said bottom wall. In this way, the contact surface of each seat is abutted against the contact surface of the respective second portion for sliding on it between the moulding configuration and the collapsed configuration.

According to another aspect of the invention a compression moulding method is provided comprising the steps of: preparing a female element for housing a dose of material suitable for compression moulding; inserting a male punch at least partly in the female element for compressing said dose, said punch having an outer moulding surface which defines, in conjunction with an inner surface of the female element, the shape of the product obtained by compressing the dose; spacing said punch from the female element; and extracting the moulded product from said punch. After the step of inserting the punch and before the step of spacing said punch at least a second portion of the punch is retracted to define a collapsed condition of the punch wherein said second portion is moved away from the dose.

The invention can be better understood and implemented with reference to the accompanying drawings which illustrate non-limiting example versions of it and in which:

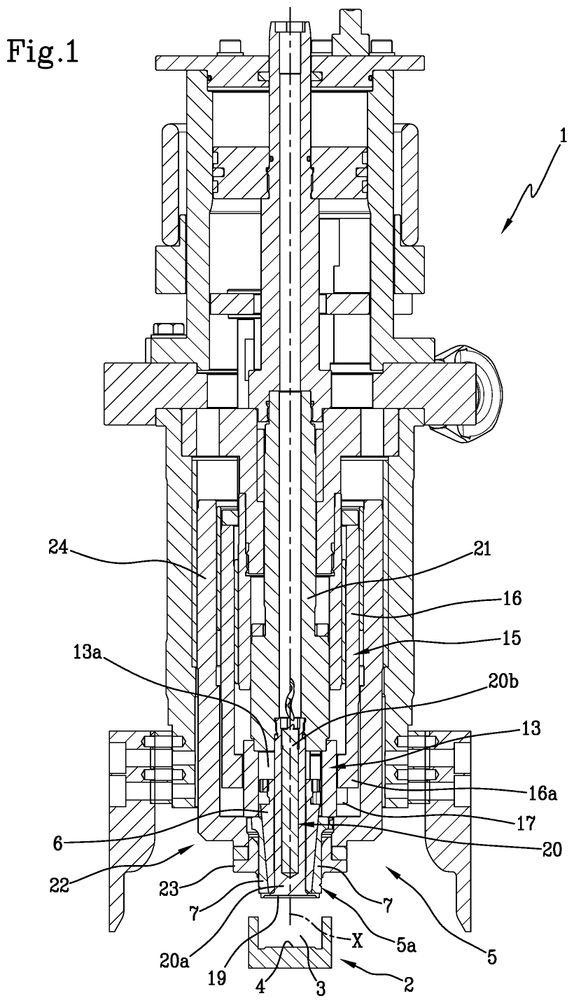

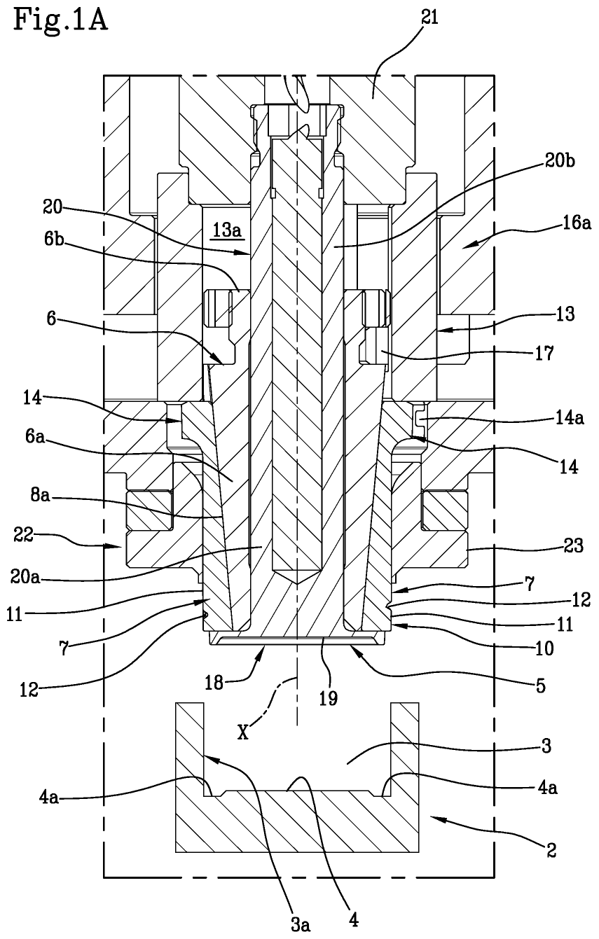

FIGS. 1 to 3 are side views and longitudinal cross sections of a compression moulding device according to the invention in respective moulding steps;

FIGS. 1a to 3a show enlargements of the respective FIGS. 1 to 3; and

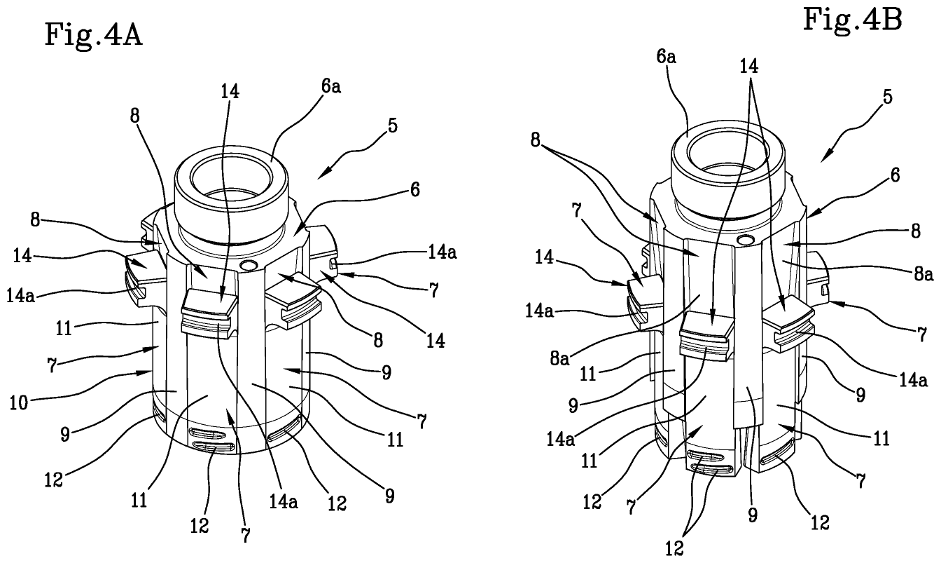

FIGS. 4a and 4b are perspective views of a construction detail of the moulding device according to the invention and in respective operating steps.

With reference to the accompanying drawings, the numeral 1 denotes in its entirety a compression moulding device according to the invention. The device 1 comprises a female element 2 for housing a dose (not illustrated in the accompanying drawings) made of material suitable for compression moulding. In particular, the female element 2, illustrated schematically in the accompanying drawings by way of a non-limiting example, has an inner compartment 3 defined by a respective inner surface 3a for forming the product to be made by moulding.

In the example illustrated, the compartment 3 and the respective surface 3a are configured to obtain a screw cap made of polymeric material, preferably cellulose-based.

In this situation it should also be noted that the compartment 3 has a bottom wall 4 on which can be made an annular recess 4a designed to form a respective annular protrusion on a wall of the finished product (cap).

The device 1 also comprises a male punch 5 which can be at least partly inserted in the compartment 3 defined by the female element 2 for compressing the dose and making the respective product.

It should be noted that the accompanying drawings do not illustrate the step of inserting the punch 5 in the compartment 3, in order to better illustrate the structure of the punch 5. For this reason, the male punch 5 and the female element 2 are always illustrated by way of example in the drawings spaced from each other.

In particular, the male punch 5 has an outer surface 10, preferably having a cylindrical shape, for moulding the dose designed to impart, in conjunction with the surface 3a of the female element 2, the shape to the finished product. Advantageously, in the case illustrated wherein the device 1 is used for moulding screw caps, the cylindrical outer surface 10 of the punch 5 defines the inner surface of the cap, provided with a thread, whilst the surface 3a of the female element 2 defines the external appearance of the cap.

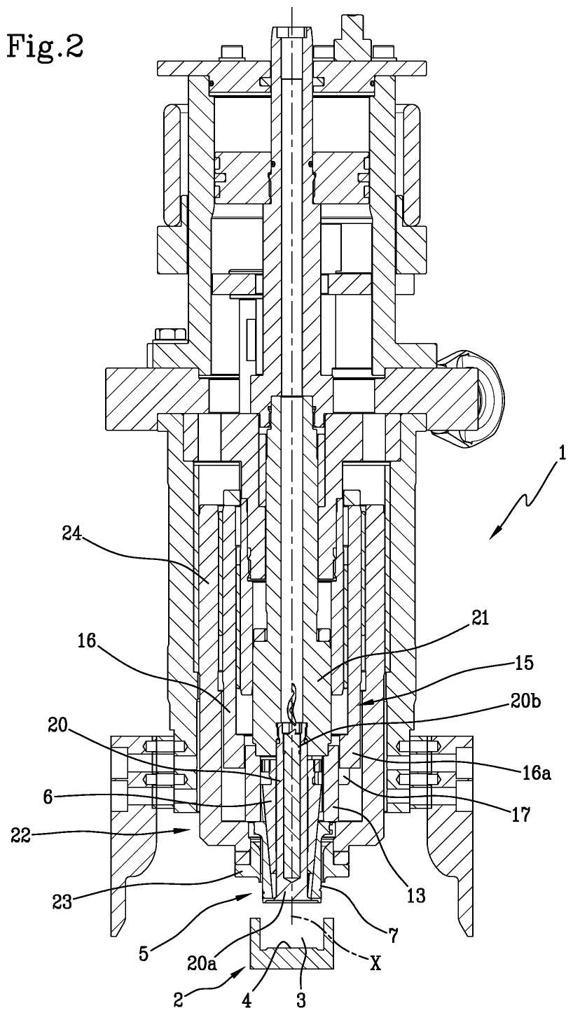

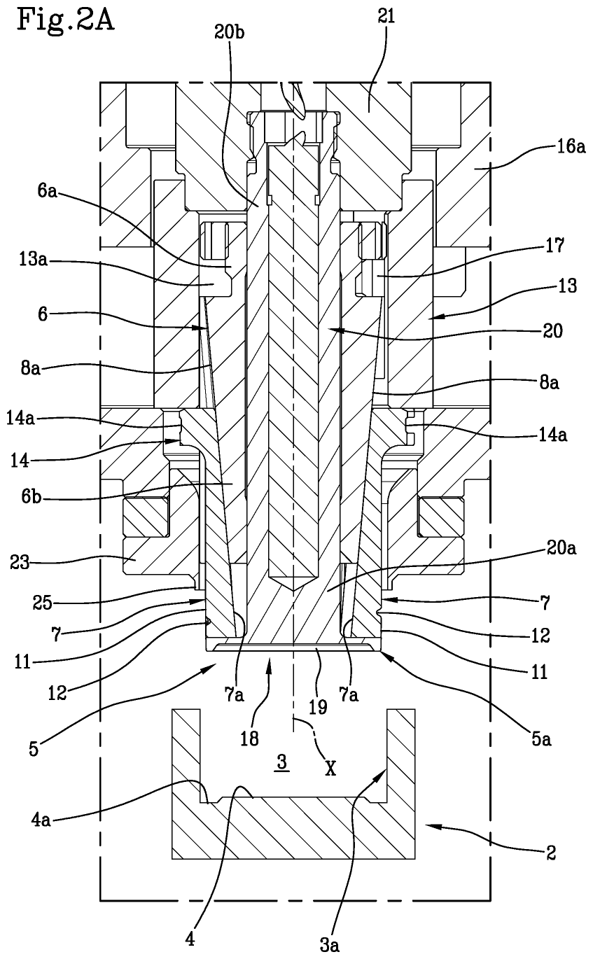

The punch 5 comprises a first portion 6 slidable relative to at least a second portion 7 between a moulding condition (FIGS. 1, 1a, 4a) wherein the second portion 7 radially compresses the dose against the female element 2 and a collapsed condition (FIGS. 2, 2a, 4b) wherein the second portion 7 is radially retracted away from the dose.

More specifically, as illustrated in more detail in FIGS. 4a and 4b, the first portion 6 has a substantially cylindrical shape wherein a plurality of seats 8 are made on the respective outer extension, alternated with a plurality of outer surfaces 9.

It should be noted that the seats 8 alternated with the surfaces 9 are equally spaced from each other and extend radially relative to the circular cross-section of the cylindrical extension of the first portion 6. Further, the seats 8 and the respective surfaces 9 extend along a longitudinal direction of extension of the first portion 6.

Each seat 8 also has a contact surface 8a inclined and converging towards an end 5a of the punch 5 close to the above-mentioned bottom wall 4 of the female element 2.

In other words, with reference to the cross-section views of FIGS. 1a-3a, it should be noted that the inclined contact surface 8a of each seat 8 is oblique relative to the longitudinal axis of extension “X” of the punch 5 and defines a variation of cross-section of the first portion 6. In this way, the first portion 6 has a transversal cross-section decreasing towards the above-mentioned end 5a of the punch 5.

Moreover, in this situation it should be noted that the outer surfaces 9 of the first portion 6 protrude more than the inclined planes 8a of the seats 8. These outer surfaces 9 lie along the extension of the cylindrical outer surface 10 of the punch 5.

Advantageously, the punch 5 comprises a plurality of second portions 7, each of which housed in a respective seat 8 of the first portion 6.

As described in more detail below, the second portions 7 are movable radially towards/away from the longitudinal axis of extension “X” of the first portion 6.

In this situation, it should be noted that each second portion 7 defines a sector of the first portion 6 which, housed in the respective seat 8, completes the cylindrical profile of the first portion 6.

In more detail, each second portion 7 comprises an outer surface 11 adjacent to and interposed between two outer surfaces 9 of the first portion 6.

For this reason, the outer surfaces 9, 11 of the first 6 and second 7 portions in the moulding condition (FIGS. 1, 1a, 4a) define the above-mentioned outer moulding surface 10 of the punch 5.

Preferably, the outer surface 11 of each second portion 7 may have cavities 12 configured to define a thread of the product to be moulded (cap) or other shaping of the finished product.

As better illustrated in the cross-section views of FIGS. 1a to 3a, each second portion 7 comprises an inclined contact surface 7a, opposite the respective outer surface 11, and converging towards the end 5a of the punch 5.

In other words, the contact surface 7a of each second portion 7 defines a variable transversal cross-section of the respective portion 7 and increasing towards the end 5a of the punch 5.

Advantageously, the contact surface 8a of each seat 8 abuts against the contact surface 7a of the respective second portion 7 for sliding on it between the moulding configuration and the collapsed configuration. In other words, the respective contact surfaces 7a, 8a are complementary to each other for radially moving the second portions 7 following the sliding of the first portion 6.

It should be noted in particular that the first portion 6 is movable along the longitudinal axis of extension “X” towards/away from the female element 2 to define the above-mentioned moulding and collapsed conditions.

The movement of the first portion 6 away from the female element 2 causes the sliding of the inclined surface 8a of the seats 8 on the inclined surface 7a of each second portion 7.

Following this sliding, illustrated in FIGS. 2a, 3a and 4b, the second portions 7 are moved inside the seat 8 and radially towards the longitudinal axis “X”.

In this situation, which is better illustrated in FIG. 4b, in the collapsed condition the outer surfaces 11 of the second portions 7 are positioned inside a containment space defined by the outer moulding surface 10 of the punch 5.

It should be noted that the portions 7 are free to move radially, towards/away from each other but are held in position along the direction of movement of the first portion 6 and along the axis “X”. For this purpose, an annular sleeve 13 is provided, positioned above the second portions 7 and internally hollow to allow the sliding inside it of the first portion 6. The sleeve 13, which is better illustrated in FIGS. 1 to 3, is fixed and defines inside a chamber 13a for housing a top zone 6a of the first portion 6 positioned above the seats 8 and the second portions 7.

Moreover, the sleeve 13 defines a stop for the second elements 7, preventing them from being lifted and lowered by the translation movement of the first element 6.

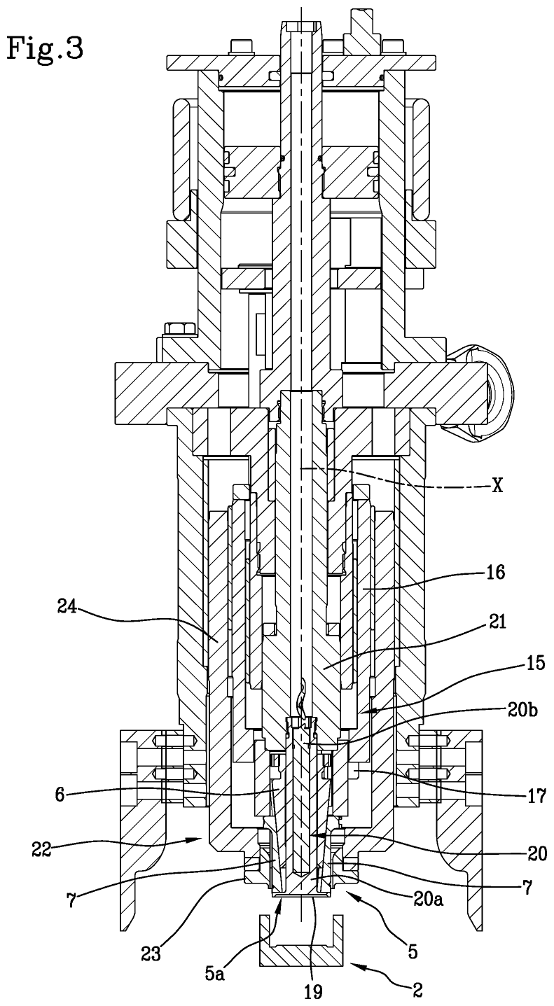

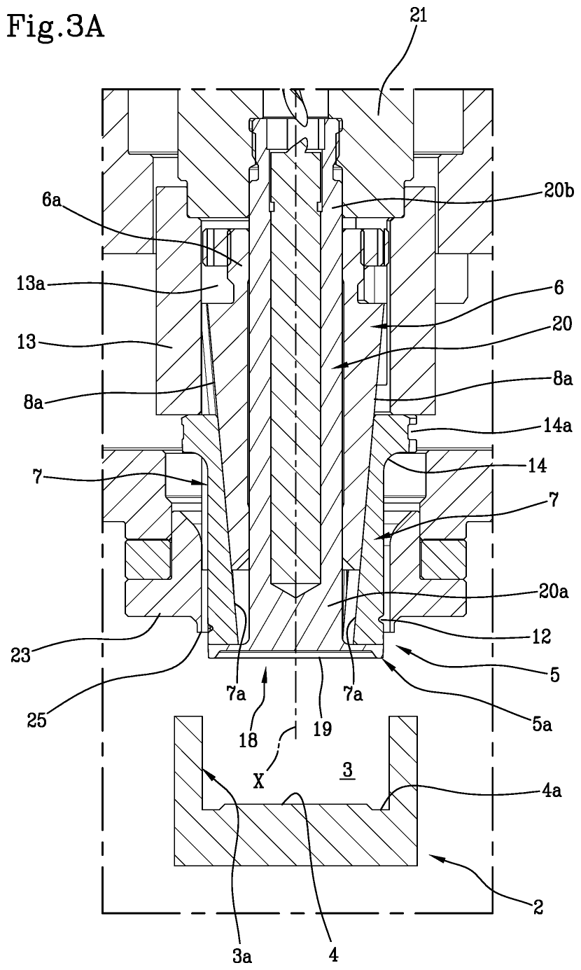

Advantageously, in the collapsed condition, which is better illustrated in FIGS. 2a and 3a, the second portions 7 have the respective contact surface 7a abutted against an end zone of the contact surface 8a of the respective seats 8 located at a lower portion 6b of the first portion 6 opposite the top zone.

The lower portion 6b is positioned at the end 5a of the punch 5 close to the bottom wall 4 of the female element 2.

The radial movement of the second portions 7 towards each other which occurs in the respective collapsed condition is preferably actuated by an elastic actuator (not illustrated in the accompanying drawings). The actuator imparts a pushing action of the second portions 7 towards the longitudinal axis of extension “X” of the first portion 6.

Preferably, the elastic actuator comprises an elastic ring housed in grooves 14a made on a protruding portion 14 of each second portion 7.

The protruding portions 14 of the second portions 7, which define abutment walls abutted against the sleeve 13, have the respective grooves 14a arranged circumferentially around the punch 15. In this way, the elastic ring is housed in the grooves 14a in such a way as to be positioned coaxially and outside the first portion 6.

The axial movement of the first portion 6 is preferably actuated by a lifting unit 15, for example of the electro-mechanical type, which acts on the top zone 6a of the first portion 6.

The lifting unit 15 comprises a tubular body 16, concentric with the longitudinal axis “X”, provided with a slider 17 protruding from a respective end 16a close to the first portion 6. The slider 17 passing through the sleeve 13 operates on the top zone 6a so as to pull the first portion 6 in the linear movement towards/away from the female element 2.

Advantageously, the device 1 also comprises a fixed third portion 18, associated with the first portion 6 and having a pressing wall 19 positioned at the end 5a of the punch 5.

The pressing wall 19 has a substantially disc-shaped extension and is configured for pressing the dose against the above-mentioned bottom wall 4 of the female element 2.

For this reason, the pressing wall 19 defines in conjunction with the outer surfaces 9, 11 of the first 6 and second 7 portions, the above-mentioned outer cylindrical surface 10 for moulding the dose.

Preferably, the third portion 18 has a cylindrical body 20 coaxially inserted inside the first portion 6.

The cylindrical body 20, which passes through the entire first portion 6, has a lower end 20a close to the female element 2 on which the pressing wall 19 extends. On the opposite side of the lower end 20a there is an upper end 20b rigidly engaged with a supporting body 21 of the entire punch 5.

The upper end 20b extends in the chamber 13a which is defined inside the sleeve 13 and closed by the supporting body 21.

In this situation it should be noted that the first portion 6 in its axial movement slides and is guided along the upper end 20b of the cylindrical body 20.

The device 1 also comprises an extraction unit 22 positioned around the male punch 5 and movable axially along the longitudinal axis of extension “X” of the first portion 6.

The extraction unit, which allows the product to be removed at the end of the compression action from the punch 5, comprises an annular element 23 extending around the moulding surface 10 and supported at the end of a supporting body 24 which is hollow inside and surrounding the tubular body 16.

The supporting body 24 is moved by respective electro-mechanical actuators (not illustrated) for lifting and lowering the annular element towards/away from the female element 5.

Advantageously, the annular element 23 is moved (FIGS. 3 and 3a), in the collapsed condition of the second portions 7, for removing the moulded product from the punch 5. For this purpose, the annular element 23 is provided with a circular pushing lip 25 configured to abut on the moulded product in the extraction action.

The invention also relates to a compression moulding method.

The method comprises the step of preparing the female element 2 for housing the dose made of material suitable for compression moulding, typically a cellulose-based polymer.

Subsequently, the punch 5 and the female element 2 are moved relative to each other to insert the punch 5 at least partly in the female element 2.

This action allows the compression of the dose and the making of the product according to the shape set by the outer moulding surface 10 and by the inner surface 3a of the female element 2.

It should be noted that in this situation, the punch 5 is in the respective moulding condition (FIGS. 1 and 1a) wherein the outer surfaces 9, 11 of the first and second portions 6, 7 define the above-mentioned moulding surface 10. In this situation, the contact surfaces 6a, 7a abut and match each other and the first portion is close to the pressing wall 19.

Subsequently, the punch 5 is spaced from the female element 2 and the second portions 7 are retracted to define the collapsed condition of the punch 5. In this situation, each second portion 7 is moved away from the product previously moulded. In other words, the second portions 7 space the respective outer surfaces 11 from the inner surface 3a of the female element 2.

The step of withdrawing the second portions 7 is actuated at the same time by axially moving the first portion 6 away from the female element 2.

In particular, thanks to the action of the lifting unit 15, the first portion 6 is moved into the chamber 13 along the end 20b of the cylindrical body 20 (FIGS. 2 and 2a).

Consequently, the contact surfaces 8a of the seats 8 are made to slide on the contact surfaces 7a of the respective second portions 7. This movement defines the collapsed condition wherein the second portions 7 are retracted and positioned inside a space of the punch 5 defined by the cylindrical outer moulding surface 10.

It should be noted that this movement of the second portions 7 makes it possible to release the cavities 12 made on the second portions 7 from the protrusions (threads) formed on the product during the action of pressing the dose.

In other words, the movement of the second portions 7 allows the threads to be “freed”, allowing removal of the product obtained without having to deform the threads.

Subsequently, the moulded product is extracted from the punch 5.

The extracting step is actuated by the annular element 23 which moved towards the end 5a removes the product from the punch 5.

Subsequently, the first portion 6 is returned to the initial condition to define the outer cylindrical pressing surface 10 and proceed with a new moulding action.

The invention therefore overcomes the drawbacks of the prior art and brings important advantages.

Firstly, it should be noted that the collapsed condition of the punch 5, wherein the second portions are moved radially inside the cylindrical moulding surface 10, makes it possible to release any type of projection, such as, for example, threads, which are obtained on the lateral wall of the product.

Consequently, just the extraction action actuated by pushing the product out of the punch 5 allows the removal of the product just moulded.

Consequently, no zone of the product is subjected to stress and deformation of any kind, thus maintaining the perfect condition of the product.

For this reason, the device 1 described above and the relative method are particularly versatile since they allow the moulding of many materials, even those most fragile and subject to deformation or damage, such as in particular cellulose-based polymers.

1. A compression moulding device, comprising:
a female element (2) for housing a dose of material suitable for compression moulding;
a male punch (5) at least partly insertable in the female element (2) for compressing said dose and making a relative product;
wherein said male punch (5) has an outer surface (10) for moulding the dose, and wherein said male punch (5) comprises a first portion (6) slidable relative to at least a second portion (7) between a moulding condition wherein the second portion (7) radially compresses the dose against the female element (2) and a collapsed condition wherein the second portion (7) is radially retracted away from the dose;
the first portion (6) having a cylindrical shape having a plurality of seats (8) alternated with a plurality of outer surfaces (9), wherein said male punch (5) comprises a plurality of second portions (7) each of which housed in a respective seat (8) of the first portion (6);
and wherein said male punch (5) also comprises a fixed third portion (18), associated with the first portion (6) and having a pressing wall (19) positioned at the end of the male punch (5a) for pressing the dose against the bottom wall (4) of the female element (2).

2. The device according to claim 1, wherein each second portion (7) comprises an outer surface (11) adjacent to and interposed between two outer surfaces (9) of the first portion (6) and having cavities (12) configured to define a thread of the product to be moulded; said outer surfaces (9, 11) of the first and second portions (6, 7) in the moulding condition defining said outer moulding surface (10).

3. The device according to claim 2, wherein said seats (8) of the first portion (6) are arranged circumferentially along the cylindrical extension of the first portion (6); said second portions (7) being movable radially towards/away from the longitudinal axis of extension (X) of the first portion.

4. The device according to claim 2, wherein each seat (8) comprises a contact surface (8a) inclined and converging towards an end (5a) of the male punch (5) close to a bottom wall (4) of the female element (2); and wherein each second portion (7) comprises a contact surface (7a) inclined and converging towards the end (5a) of the male punch (5) close to said bottom wall (4); said contact surface (8a) of each seat (8) abutting the contact surface (7a) of the respective second portion (7) to slide thereon between the moulding configuration and the collapsed configuration.

5. The device according to claim 4, wherein said first portion (6) is movable along said longitudinal axis of extension (X) to define said moulding and collapsed conditions; each portion (7) in the collapsed condition having the respective contact surface (7a) abutting an end zone of the contact surface (8a) of the respective seat (8) close to the bottom wall (4).

6. The device according to claim 2, wherein said male punch (5) also comprises an elastic pushing actuator associated with said second portions (7) for pushing said portions towards said longitudinal axis of extension (X) of the first portion (6); said outer surfaces (11) of the second portions (7) in the collapsed condition being positioned inside a containment space defined by said outer moulding surface (10) of the male punch (5).

7. The device according to claim 6, wherein said elastic actuator comprises an elastic ring housed in grooves (14a) made in each second portion (7); said elastic ring being positioned coaxially and outside the first portion (6).

8. The device according to claim 7, wherein said third portion (18) has a cylindrical body (20) coaxially inserted at least partly inside the first portion (6); said pressing wall (19) being associated with an end (20a) of the cylindrical body (20) close to the female element (2).

9. The device according to claim 8, wherein the pressing wall (19) defines in conjunction with the outer surfaces (9, 11) of the first and second portions (6, 7) said outer surface (10) for moulding the dose.

10. The device according to claim 9, wherein said second portions (7) in the collapsed condition are positioned inside a perimeter defined by a peripheral edge of the pressing wall (19).

11. The device according to claim 4, wherein it also comprises an extraction unit (22) positioned around said male punch (5) and movable axially along said longitudinal axis of extension (X).

12. The device according to claim 11, wherein said extraction unit (22) comprises an annular element (23) extending around the moulding surface (10); said annular element (23) sliding towards the end (5a) of the male punch (5) in the respective collapsed condition for extracting a moulded product following the action of pressing the dose.

13. A compression moulding method comprising the steps of:
preparing a female element (2) for housing a dose of material suitable for compression moulding;
inserting a male punch (5) at least partly in the female element (2) for compressing said dose, said male punch (5) having an outer moulding surface (10) which defines, in conjunction with an inner surface (3a) of the female element (2), the shape of the product obtained by compressing the dose;
spacing said male punch (5) from the female element (2); and
extracting the moulded product from said male punch (5);
wherein after the step of inserting the male punch (5) and before the step of spacing said male punch (5) at least a second portion (7) of the male punch (5) is retracted to define a collapsed condition of the male punch (5) wherein said second portion (7) is moved away from the dose;
wherein the method further comprises a step of withdrawing a plurality of second portions (7) axially moving a first portion (6) having a plurality of seats (8) for housing said second portions (7);
said step of axially moving the first portion (6) being actuated by simultaneously sliding a plurality of inclined contact surfaces (8a), each of which housed in the respective seat (8), on inclined contact surfaces (7a) of the respective second portions (7); said second portions (7) in the collapsed condition being positioned inside a space of the male punch (5) defined by the outer moulding surface (10);
wherein said step of spacing the male punch (5) from the female element (2) comprises the step of moving a pressing wall (19) of the male punch (5) away from a bottom wall (4) of the female element (2).

14. The method according to claim 13, wherein said step of extracting the moulded product is actuated by axially moving an annular element (23) extending around the moulding surface (10) towards the end (5a) of the male punch (5) in the respective collapsed condition for extracting a moulded product following the action of pressing the dose.
